(19) United States
(12) Patent Application Publication
(10) Pub. No.: US 2003/0102198 A1
(43) Pub. Date: Jun. 5, 2003

(54) Earthquake-proof support for escalators or travelors

(76) Inventors: Harald Nusime, Laxenburg (AT); Eduard Harmel, Klosterneuburgerstrasse (AT)

Correspondence Address: SCHWEITZER CORNMAN GROSS & BONDELL LLP, 292 MADISON AVENUE - 19th FLOOR, NEW YORK, NY, 10017, US

(21) Appl. No.: 10/339,220

(22) Filed: Jan. 9, 2003

Related U.S. Application Data
(63) Continuation of application No. PCT/CH01/00457, filed on Jul. 24, 2001.

(30) Foreign Application Priority Data
Jul. 27, 2000 (EP) 00810670.0

(51) Int. Cl. B65G 15/00; B66B 21/00

(52) U.S. Cl. 198/321

(57) ABSTRACT

During an earthquake, escalators are subjected to longitudinal displacement, which may cause excessive movement of a bearing girder out of the supporting area and may result in the escalator crushing down. Securing elements in the form of bolts or ropes are provided to limit the movement of the bearing girder within the supporting area and prevent the escalator from crashing down. When ropes are utilized, they may be securely fixed to fastenings located on a supporting base by the manufacturer. On site, the ropes may be pulled through holes in the provided support and looped over a rope rod. The rope rod is located on a provided bracket. When, in the case of a catastrophe, the provided bracket is unable to withstand the forces, the rope rod is stopped at the hole without the escalator crashing down.

The present application is a continuation of PCT/CH01/00457.

This invention relates to an escalator or a travelator consisting of a supporting base, a stepped conveyor or a flat conveyor for transporting persons and objects and a balustrade with a handrail, with supports being provided at the escalator or travelator ends for holding the supporting base in place within the building structure.

### BACKGROUND OF THE INVENTION

Document JP 09058956 disclosed a top support for an escalator, which on each side is secured by an upright retaining girder included in the building structure, preventing longitudinal displacement caused by earthquakes. Longitudinal displacement is limited by a stop located on the retaining girder. In the event of the bearing girder breaking, the top end of the escalator is supported by the retaining girder.

A disadvantage of use of a retaining girder is that it takes up too much space and can only be used with certain escalator support structures.

The present invention aims to remedy this situation. The invention provides a support that holds the escalator or travelator in the event of a disaster and that can be easily implemented from a design point of view.

The invention comprises securing elements located at at least one end of the escalator or travelator which retain the escalator or travelator to the building structure in the event of earthquake forces and the like. The securing elements may comprise a stud bolt as a securing element. The stud bolt penetrates a bearing girder of the escalator or travelator and bears a nut to prevent upward movement of the girder. Alternative securing elements, such as ropes, may also be utilized.

The advantages offered by the invention include that the securing elements are independent from the escalator and prevent, where forces are exerted as part of a disaster such as an earthquake, the escalator or travelator from leaving the top support area. As a result, damage to the building and/or the escalator or travelator is prevented.

### BRIEF DESCRIPTION OF THE DRAWINGS

The invention is explained in more detail in the following description of illustrative embodiments thereof with reference to the annexed drawings, wherein:

FIG. 1 is a diametric side view of an escalator incorporating the invention;

FIG. 2 is a top plan view of the escalator of FIG. 1;

FIG. 3 is an elevation view of area A of FIG. 1 with details of a bolt, serving as securing element, at the top end of the escalator;

FIG. 4 is a section view of the securing element along line B-B of FIG. 3;

FIG. 5 is an alternative view of Area A showing a rope serving as the securing element;

FIG. 6 depicts the activated securing element of FIG. 5; and

FIG. 7 is a horizontal section of the construction of FIG. 5.

### DETAILED DESCRIPTION OF THE INVENTION

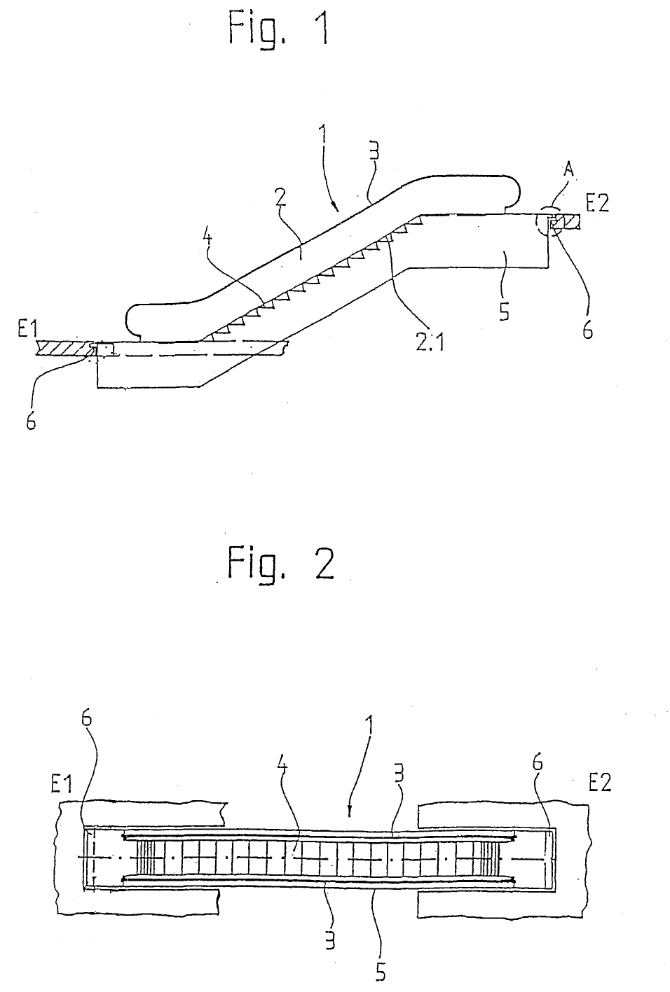

FIGS. 1 and 2 show a side view and a top view of an escalator 1, connecting a first floor E1 to a second floor E2. The escalator 1 contains a stepped conveyor 4 consisting of steps. A handrail 3 is attached to each balustrade 2 that is held by a balustrade base 2.1 at its bottom end. The balustrade base 2.1 is supported by a supporting base 5 of escalator 1.

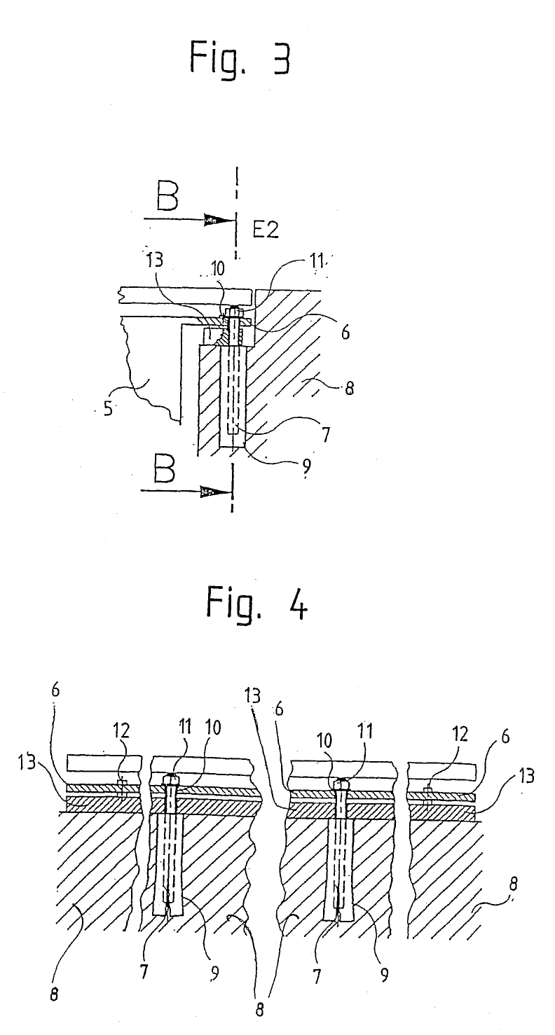

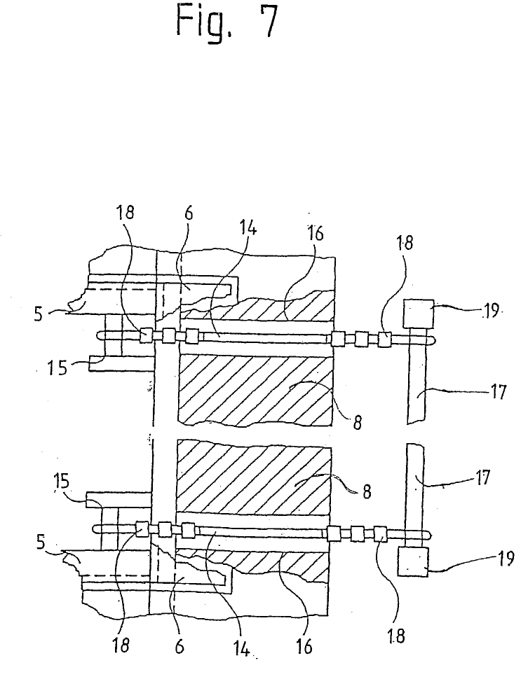

The invention can also be applied to travelators using flat conveyors. In the course of further description, reference is only made to escalators instead of “escalators and travelators” although the contents of the-embodiments also apply to a travelator. Area A of the supporting structure at the top end of the escalator is shown in FIGS. 3 to 7.

FIG. 3 shows details of the support located at the top end of the escalator with at least one stud bolt 7 as a securing element, preventing the escalator 1 from leaving the top bearing area. A bearing girder 6 of the escalator's supporting base 5 rests on a support 8, provided on site, that consists, i.e. of concrete. The stud bolt 7 which may, for instance, be connected to the provided support 8 via a dowel 9, penetrates a hole 10 of the bearing girder 6 and contains a nut 11 at the top end, preventing an upward movement of the bearing girder 6. The stud bolt 7 can also contain a cushioning sleeve in the area of hole 10, cushioning the longitudinal displacement of the bearing girder 6.

As shown in FIG. 4, the bearing girder 6 is adjusted with adjusting screws 12 resting on a support element 13. After adjustment, the nut 11 of each stud bolt 7 is tightened.

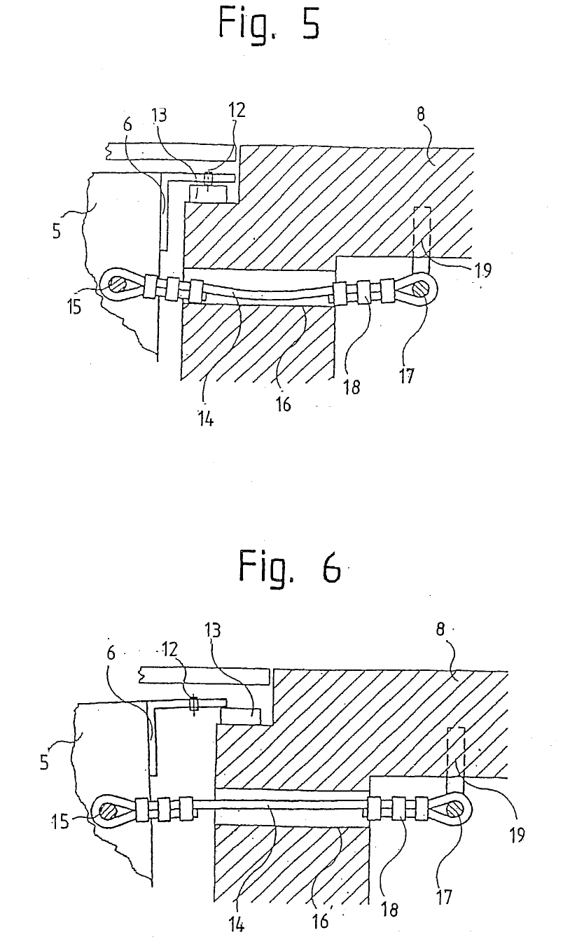

FIGS. 5 to 8 show ropes 14 that serve as securing elements and are located below the top support. Each rope 14 is securely fixed to a fastening 15, located on the supporting base 5, by the escalator manufacturer. On site, the rope 14 is, for instance, pulled through a hole or bore 16 of a provided support 8 and looped over a rope rod 17. The unattached end of the rope 14 is fixed with rope clamps 18. The rope rod 17 is located on provided brackets 19. FIG. 6 shows a disaster event during which the ropes 14 prevent the escalator 1 from crashing down.

If, in the event of a disaster, the provided brackets 19 cannot withstand the force, the rope rod 17 is still stopped at the holes 16, whereby the escalator is still supported by the ropes, without the escalator 1 crushing down. The rope option can also be combined with the bolt option shown in FIGS. 3 and 4. In this embodiment, the escalator 1 is secured by stud bolts 7 and nuts 11. In the event of the bearing girder 6 breaking and/or the support breaking away from the building structure, ropes 14 continue to secure escalator 1 against crashing down. The securing elements of the invention can also be used with the escalator bottom support.

We claim:

1. An escalator or travelator, comprising a supporting base, a stepped or flat conveyor for transporting persons and objects, and a balustrade with a handrail, with supports being provided at ends of the escalator or travelator for holding the supporting base within a building structure, characterized by at least one securing element being provided at at least one of the ends of the escalator or travelator for preventing in the event of forces being exerted in the event of a catastrophe the escalator or the travelator from leaving a supporting area, the securing element connecting the escalator or travelator to the building structure.

2. The escalator or travelator according to claim 1, wherein the securing element comprises a stud bolt located on a provided support, the stud bolt penetrating a bearing girder of the escalator or the travelator and having a nut mounted thereon above the bearing girder to prevent an upward movement of the bearing girder.

3. The escalator or travelator according to claim 1, wherein the securing element comprises a rope having a first end connected to the escalator or the travelator and a second end connected to the building structure.

4. The escalator or travelator according to claim 3, further comprising a rope rod located on a bracket mounted to the building structure, the second end of the rope being connected to the rope rod, the rope rod being dimensioned and constructed to be retained by the building structure in the event of bracket failure.

5. The escalator or travelator according to claim 4, wherein the rope passes through a bore in the building structure, the rope rod being dimensioned and constructed to be unable to pass through the bore.
